(19) United States
(12) Patent Application Publication
(10) Pub. No.: US 2019/0113683 A1
(43) Pub. Date: Apr. 18, 2019

(54) OPTICAL MODULATION DEVICE

(71) Applicant: Sumitomo Osaka Cement Co., Ltd, Chiyoda-Ku, Tokyo (JP)

(72) Inventors: Hara TOKUTAKA, Chiyoda-Ku (JP); Ryo SHIMIZU, Chiyoda-Ku (JP)

(21) Appl. No.: 16/090,329

(22) PCT Filed: Mar. 24, 2017
(86) PCT No.: PCT/JP2017/011937

§ 371 Date: Oct. 1, 2018

(30) Foreign Application Priority Data
Mar. 31, 2016 (JP) 2016-070473
Mar. 31, 2016 (JP) 2016-070474
Mar. 31, 2016 (JP) 2016-070475

(51) Int. Cl. G02B 6/27; G02B 6/30; G02B 6/32

(52) U.S. Cl. CPC G02B 6/272; G02B 6/32; G02B 6/30

(57) ABSTRACT

There is provided an integration-type optical modulation device which performs polarization-beam-combining on two linearly polarized light beams respectively output from a plurality of optical modulation elements and outputs the resultant beam so as to seek an improvement and stabilization of optical characteristics, miniaturization, and low cost. The optical modulation device includes: two optical modulation elements (120a and the like) that respectively output two output light beams; four lenses (140a and the like) that respectively receive the four output light beams output from the optical modulation elements; a polarization rotation element (108) that together rotates polarization direction of respective ones of the respective two output light beams output from the two optical modulation elements; and two polarization beam combining elements (110a and 110b) that respectively combine the two output light beams respectively output from the two optical modulation elements into one beam and output the one beam, in which the light beams respectively output from the four lenses are directly input to the polarization rotation element and/or the two polarization beam combining elements without passing through an optical path shift prism.

### TECHNICAL FIELD

Certain embodiments of the present invention relate to an optical modulation device that modulates light beams input from one optical fiber by an optical modulation element and outputs the resultant modulated light beams from another optical fiber, and particularly to, an integration-type optical modulation device that includes a plurality of optical modulation elements which are formed on separate substrates, or are formed on one substrate side by side, and performs polarization beam combining of two linearly polarized light beams, which are modulated and are output from the plurality of optical modulation elements.

### BACKGROUND ART

In a high-frequency and large-capacity optical fiber communication system, optical modulators including a waveguide-type optical modulation element have been widely used. With regard to the optical modulators, an optical modulation element, in which LiNbO₃ (hereinafter, also referred to as “LN”) having an electro-optic effect is used for a substrate, is widely used in a high-frequency and large-capacity optical fiber communication system when considering that it is possible to realize wide-band optical modulation characteristics with a low optical loss.

In the optical modulation element using the LN, for example, a Mach-Zehnder type optical waveguide is formed on the LN substrate, and when a high-frequency signal is applied to an electrode formed in the vicinity of the optical waveguide, a modulated signal light beam (hereinafter, referred to as “modulated light beam”) corresponding to the high-frequency signal is output. In addition, in a case of using the optical modulation element in an optical transmission device, an optical modulation device, which includes a housing in which the optical modulation element is accommodated, an input optical fiber through which a light beam from a light source is input to the optical modulation element, and an output optical fiber that guides the light beam output from the optical modulation element to the outside of the housing, is used.

With regard to a modulation mode in the optical fiber communication system, a transmission format in which polarization multiplexing is introduced becomes a mainstream from the recent trend of an increase in transmission capacity. Examples of the transmission formation include dual polarization-quadrature phase shift keying (DP-QPSK), dual polarization-quadrature amplitude modulation (DP-QAM), and the like in which two linearly polarized light beams in polarization directions orthogonal to each other are subjected to phase shift keying or quadrature amplitude modulation and are transmitted by one optical fiber.

In the optical modulation device that performs the DP-QPSK modulation or the DP-QAM modulation, a linearly polarized light beam output from one light source is input to the optical modulation element. In the optical modulation element, the input linearly polarized light beam is branched into two light beams, and the two light beams are modulated by using two independent high-frequency signals. The two linearly polarized modulation light beams, which are modulated, are combined into one light beam and the resultant light beam is output in a state of being coupled to one optical fiber.

On the other hand, for example, consideration is given to the following wavelength multiplexing system so as to further increase transmission capacity of the optical transmission system. Specifically, the DP-QPSK modulation or the DP-QAM modulation is performed with respect to a plurality of light beams having wavelengths different from each other, and the plurality of modulated light beams having wavelengths different from each other are collected as one light beam by using a wavelength combiner. The resultant light beam is transmitted by one optical fiber. In an optical transmission device in which a plurality of light beams are respectively modulated and are transmitted by one optical fiber, from the viewpoint of miniaturization of the device and the like, there is a demand for an integration-type optical modulation device that includes a plurality of optical modulation elements (or an integration-type optical modulation element in which a plurality of optical modulation elements are formed on one LN substrate) in one housing.

In this case, in general, it is necessary to extend a distance between two linearly polarized light beams output from one optical modulation element and two linearly polarized light beams output from another optical modulation element from the necessity for securing a space for optical components such as a polarization beam combiner that combines light beams (linearly polarized light beams) output two by two from each of the plurality of optical modulation elements, and a lens that couples light beams output from the polarization beam combiner to an optical fiber.

As the integration-type optical modulation device, in the related art, there is known the following integration-type optical modulation device including two optical modulation elements. After a distance between two linearly polarized light beams output from one optical modulation element and two linearly polarized light beams output from the other optical modulation element is extended by using two optical path shift prisms (that is, prisms for parallel movement of an optical path, hereinafter, referred to as “optical path shift prism”), the two linearly polarized light beams output from each of the optical modulation element are combined into one light beam by a polarization beam combining prism and the like, and the resultant light beam is output to the outside of a housing by one optical fiber (Patent Literature No. 1).

In the optical modulation device, distances from the two optical modulation elements to the two optical path shift prisms are made to be different from each other. According to this, damage of an optical component, which occurs when the two optical path shift prisms come into contact with each other and the like, is prevented.

However, in a case of constituting the optical modulation device, it is required to reduce the number of optical components which are inserted into an optical path as possible from the viewpoint of an improvement in optical coupling efficiency between the optical modulation element and an output optical fiber, from the viewpoint of stabilization of a temperature variation or a variation with the passage of time in the optical coupling efficiency, and from the viewpoint of a reduction in a device size or a device cost.

That is, in the integration-type optical modulation device of the related art, there is a room for improvements from the viewpoints of an improvement and stabilization of optical characteristics, miniaturization, low cost, and the like.

### CITATION LIST

### Patent Literature

[Patent Literature No. 1] Japanese Laid-open Patent Publication No. 2015-172630

### SUMMARY OF INVENTION

### Technical Problem

From the background, in an integration-type optical modulation device that includes a plurality of optical modulation elements which are respectively formed on separate substrates or are arranged on one substrate, combines two modulated and linearly polarized light beams output from each of the plurality of optical modulation elements into one light beam, and outputs the resultant light beam from one optical fiber, it is required to realize a configuration capable of realizing a further improvement from the viewpoints of an improvement and stabilization of optical characteristics, miniaturization, low cost, and the like.

### Solution to Problem

According to an aspect of the invention, there is provided an optical modulation device including: a first optical modulation element and a second optical modulation element each of which outputs two output light beams; four lenses that respectively receive the four output light beams output from the two optical modulation elements; a polarization rotation element that rotates polarization direction of one of the two output light beams from the first optical modulation element and one of the two output light beams from the second optical modulation element; a first polarization beam combining element that combines the two output light beams from the first optical modulation element into one beam and outputs the combined beam; and a second polarization beam combining element that combines the two output light beams from the second optical modulation element into one beam and outputs the combined beam, in which the light beams respectively output from the four lenses are directly input to the polarization rotation element and/or the first and second polarization beam combining elements without passing through an optical path shift prism.

According to the aspect of the invention, the polarization rotation element is one optical element including an area through which one of the two output light beams from the first optical modulation element passes and an area through which one of the two output light beams from the second optical modulation element passes.

According to the aspect of the invention, the optical modulation device further includes first and second optical path shift elements that respectively shift optical paths of the beams output from the first and second polarization beam combining elements to directions away from each other.

According to the aspect of the invention, the first optical modulation element and the second optical modulation element are disposed to output the output light beams side by side and are disposed at a line-symmetrical position with respect to a line segment parallel to the output direction in which the output light beams are output side by side, and the first polarization beam combining element and the second polarization beam combining element are disposed at the line-symmetrical position with respect to the line segment.

According to the aspect of the invention, an optical component which includes a parallel flat plate by an optical medium is disposed between the four lenses and the polarization rotation element and/or the first and second polarization beam combining element.

According to the aspect of the invention, the first and second optical modulation elements are optical modulation elements which perform phase shift keying or quadrature amplitude modulation.

According to the aspect of the invention, the first and second optical modulation elements are respectively formed on separate substrates or are formed on an identical substrate side by side.

According to the aspect of the invention, the four output lenses are an integration-type microlens array.

### BRIEF DESCRIPTION OF DRAWINGS

FIG. 1 is a view illustrating a configuration of an optical modulation device according to a first embodiment of the invention.

FIG. 2 is a partial detail view of the periphery of a microlens array in the optical modulation device illustrated in FIG. 1.

FIG. 3 is a view illustrating a configuration of an optical modulation device according to a second embodiment of the invention.

FIG. 4 is a partial detail view of the periphery of a microlens array in the optical modulation device illustrated in FIG. 3.

FIG. 5 is a view illustrating a configuration of an optical modulation device according to a third embodiment of the invention.

FIG. 6 is a partial detail view of the periphery of a microlens array in the optical modulation device illustrated in FIG. 5.

FIG. 7 is a view illustrating a modification example of the optical modulation device illustrated in FIG. 5.

### DESCRIPTION OF EMBODIMENTS

Hereinafter, embodiments of the present invention will be described with reference to drawings.

### First Embodiment

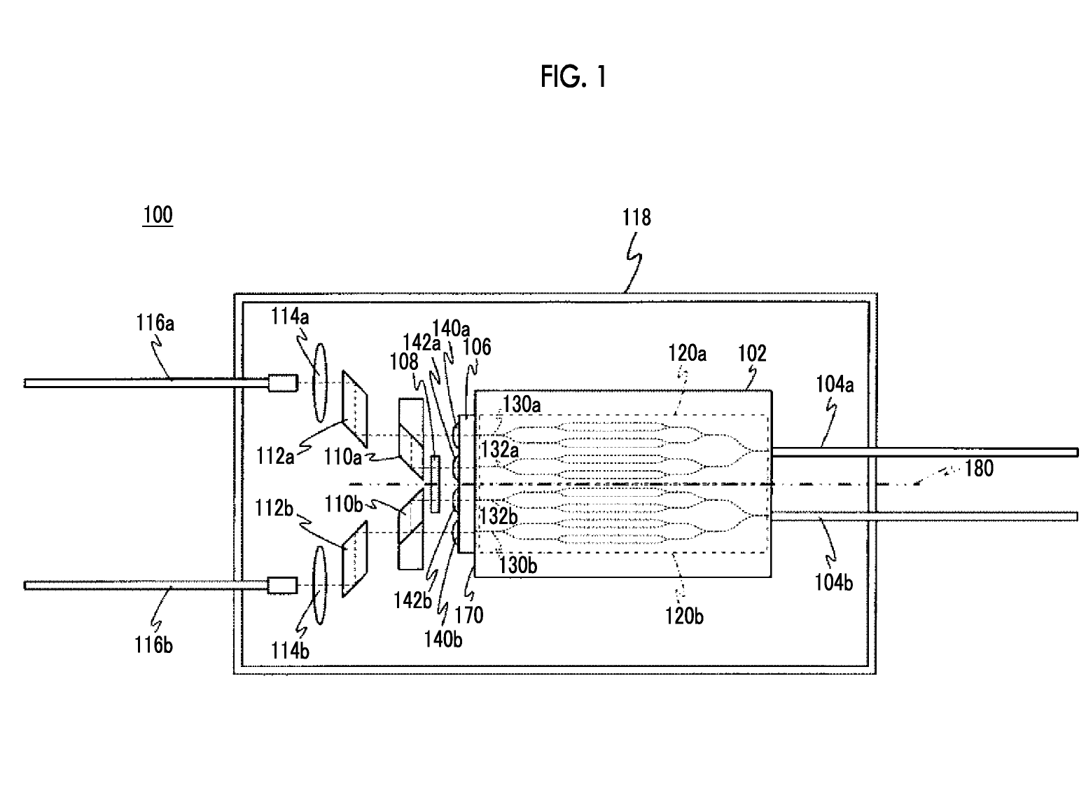

FIG. 1 is a view illustrating a configuration of an optical modulation device according to the first embodiment of the invention. An optical modulation device 100 includes an optical modulator 102, input optical fibers 104a and 104b which are optical fibers through which a light beam from a light source (not illustrated) is input to the optical modulator 102, a microlens array 106, a half-wavelength plate 108, polarization beam combining prisms 110a and 110b, optical path shift prisms 112a and 112b, coupling lenses 114a and 114b, output optical fibers 116a and 116b, and a housing 118.

For example, the input optical fibers 104a and 104b allow linearly polarized light beams, which are transmitted from two light sources (not illustrated) and have wavelengths different from each other, to be input to the optical modulator 102.

The optical modulator 102 includes two optical modulation elements 120a and 120b which are formed on one sheet of LN substrate and include optical waveguides. For example, the optical modulation elements 120a and 120b are optical modulation elements which perform DP-QPSK modulation or DP-QAM modulation.

As illustrated in FIG. 1, the optical modulation elements 120a and 120b are disposed so that the output light beams are output side by side. That is, in FIG. 1, the optical modulation elements 120a and 120b are disposed so that all of the output light beams of the optical modulation elements 120a and 120b are output from an end surface 170 on the left side in the drawing of the optical modulator 102 in the left direction side by side in the vertical direction in the drawing. In addition, the present embodiment, the optical modulation elements 120a and 120b are disposed at positions which are line-symmetrical with respect to a line segment 180 parallel to the directions of the output light beams output side by side.

In the present embodiment, the optical modulation elements 120a and 120b are disposed so that all of the output light beams output from the optical modulation elements 120a and 120b are output side by side in a linear shape in the vertical direction in FIG. 1, but the present embodiment is not limited thereto. As long as the output light beams are output “side by side”, the output light beams of the optical modulation elements 120a and 120b may be disposed so that the output light beams have predetermined positional relationship with one another. For example, the optical modulation elements 120a and 120b also may be disposed so that output end surfaces (left side end surfaces illustrated in FIG. 1) of the respective light beams of the optical modulation elements 120a and 120b are disposed to be displaced from each other by a prescribed distance in the left-right direction in FIG. 1. In addition, for example, the output light beams of the optical modulation elements 120a and 120b may be disposed so that output points of the respective light beams from the optical modulation elements 120a and 120b are different from one another in the substrate thickness direction (direction perpendicular to the page of FIG. 1) of the optical modulation elements 120a and 120b.

The optical modulation element 120a is a first optical modulation element. The linearly polarized light beam input from the input optical fiber 104a is branched into two light beams and modulated by electronic signals different from each other, and respectively output from output waveguides 130a and 132a. In addition, the optical modulation element 120b is a second optical modulation element. The linearly polarized light beam input from the input optical fiber 104b is branched into two light beams and modulated by signals different from each other, and respectively output from output waveguides 130b and 132b.

The microlens array 106 in which microlenses 140a, 142a, 140b, and 142b, which are four output lenses, are integrally formed is disposed on the substrate end surface 170 (substrate end surface on a side (that is, left side in the drawing) on which output waveguides 130a and 132a, 130b, 132b are formed) on a light beam output side of the optical modulator 102.

The light beams output from the output waveguides 130a and 132a of the optical modulation element 120a are input to the microlenses 140a and 142a and the light beams output from the output waveguides 130b and 132b of the optical modulation element 120b are input to the microlenses 140b and 142b. The light beams input to the microlenses 140a, 142a, 140b, and 142b respectively become, for example, the parallel light beam by being collimated (collimated light beam) and the resultant light beams are output.

The light beam, which is one output light beam output from the optical modulation element 120a, output from the output waveguide 132a and the light beam, which is one output light beam output from the optical modulation element 120b, output from the output waveguide 132b respectively pass through the microlenses 142a and 142b, after then, the light beams are input to the half-wavelength plate 108 together.

The half-wavelength plate 108 is a polarization rotation element. When the output light beams, which are the two linearly polarized light beams input to the half-wavelength plate 108, pass through the half-wavelength plate 108, a polarized wave of each of the output light beams is rotated by 90°. In the present description, the half-wavelength plate 108 is set to be one for the two output light beams, but the half-wavelength plate 108 may be set to be one for each of the two output light beams. However, it is possible to reduce the number of components, reduce assembly processes, and improve reliability by setting the half-wavelength plate 108 to be one for the two output light beams.

Accordingly, the light beam, which is one output light beam output from the optical modulation element 120a, output from the output waveguide 132a and the light beam, which is another output light beam output from the optical modulation element 120a, output from the output waveguide 130a become the linearly polarized light beams in the polarized wave directions orthogonal to each other and are input to the polarization beam combining prism 110a. In the same manner, the light beam, which is one output light beam output from the optical modulation element 120b, output from the output waveguide 132b and the light beam, which is another output light beam, output from the output waveguide 130b become the linearly polarized light beams in the polarized wave directions orthogonal to each other and are input to the polarization beam combining prism 110b.

Here, since wavelengths of the light beams respectively input to the input optical fibers 104a and 104b are different from each other, in a case where the wavelength of the light beam output from the output waveguide 132a of the optical modulation element 120a and the wavelength of the light beam output from the output waveguide 132b of the optical modulation element 120b are different from each other (or as necessary), in the half-wavelength plate 108, an optical thickness of an area through which the light beam output from the output waveguide 132a of the optical modulation element 120a passes and an optical thickness of an area through which the light beam output from the output waveguide 132b of the optical modulation element 120b passes may be set to be different from each other according to wavelengths of the optical thicknesses.

For example, in the half-wavelength plate 108, the half-wavelength plate 108 is disposed so that the area through which the light beam output from the output waveguide 132a of the optical modulation element 120a passes and the area through which the light beam output from the output waveguide 132b of the optical modulation element 120b passes are line-symmetrical with respect to the line segment 180. The half-wavelength plate 108 having each of the areas may be configured by one half-wavelength plate. In addition, the half-wavelength plates having the respective areas may be prepared and separately disposed, or may be combined into one.

The polarization beam combining prism 110a is a first polarization beam combining element and combines the two linearly polarized light beams output from the optical modulation element 120a in the polarization directions orthogonal to each other, into one beam and outputs the resultant beam. In addition, the polarization beam combining prism 110b is a second polarization beam combining element and combines the two linearly polarized light beams output from the optical modulation element 120b in the polarization directions orthogonal to each other, into one beam and outputs the resultant beam.

Further, for example, a polarization beam combining prism 110 is disposed so that the polarization beam combining prisms 110a and 110b are line-symmetrical with respect to the line segment 180.

The optical path shift prisms 112a and 112b are respectively first and second optical path shift elements. The optical path shift prisms 112a and 112b shift optical paths of the light beams respectively output from the polarization beam combining prisms 110a and 110b in the directions away from each other (in the directions vertically away from each other in the embodiment illustrated in FIG. 1).

The light beam output from the optical path shift prism 112a is input to the output optical fiber 116a via the coupling lens 114a and reaches the outside of the housing 118. In the same manner, the light beam output from the optical path shift prism 112b is input to the output optical fiber 116b via the coupling lens 114b and reaches the outside of the housing 118.

Accordingly, after the light beams input from the input optical fiber 104a are modulated by the optical modulation element 120a, the resultant light beams are polarization-beam-combined by the half-wavelength plate 108 and the polarization beam combining prism 110a and output from the output optical fiber 116a. In addition, in the same manner, after the light beams input from the input optical fiber 104b are modulated by the optical modulation element 120b, the resultant light beams are polarization-beam-combined by the half-wavelength plate 108 and the polarization beam combining prism 110b and output from the output optical fiber 116b.

The optical path shift prisms 112a and 112b, the coupling lenses 114a and 114b, and the output optical fibers 116a and 116b are respectively disposed so as to be mutually line-symmetrical with respect to the line segment 180, for example.

Specifically, in the optical modulation device 100 according to the present embodiment, immediately after the linearly polarized light beams output two by two from the optical modulation elements 120a and 120b pass through the microlenses 140a, 142a, 140b, and 142b (that is, without passing through another optical component such as optical path shift prisms which extend greatly an optical distance (or optical path length) between the microlenses 140a, 142a, 140b, and 142b and the half-wavelength plate 108 and/or the polarization beam combining prisms 110a and 110b), firstly, the resultant light beams pass through the half-wavelength plate 108 and/or the polarization beam combining prisms 110a and 110b and are respectively combined into one light beam. For this reason, even in a case where focal distances of the microlenses 140a, 142a, 140b, and 142b are short and divergence angles of the four light beams respectively output as Gaussian beam from the microlenses 140a, 142a, 140b, and 142b are large, it is possible to generate two beams (that is, respectively polarization-beam-combined beams) by certainly performing polarization-beam-combining before the four light beams are propagated and begin to overlap one another.

In general, light beams output from optical modulation elements are collimated (become parallel light beams) by lenses and the resultant light beams are output. The parallel light beam is a Gaussian beam having a constant beam diameter and can be ideally propagated far away while holding the constant beam diameter. However, normally, the parallel light beam has a portion (beam waist) in which the diameter of the beam becomes the narrowest. That is, the beam diameter of the parallel light beam output from the lens gradually decreases and becomes minimum in the beam waist, after then, the beam diameter increases (diverges) as characteristics. This is due to the fact that the light beam output from the optical modulation element is a point light source having a certain area and that the linearly polarized light beam is diffracted.

Therefore, the Gaussian beams respectively output two by two from the optical modulation elements 120a and 120b and respectively collimated by the microlenses 140a, 142a, 140b, and 142b respectively diverge as described above and parts of the resultant beams are started to overlap with each other at positions at which the resultant beams are propagated up to desired distances.

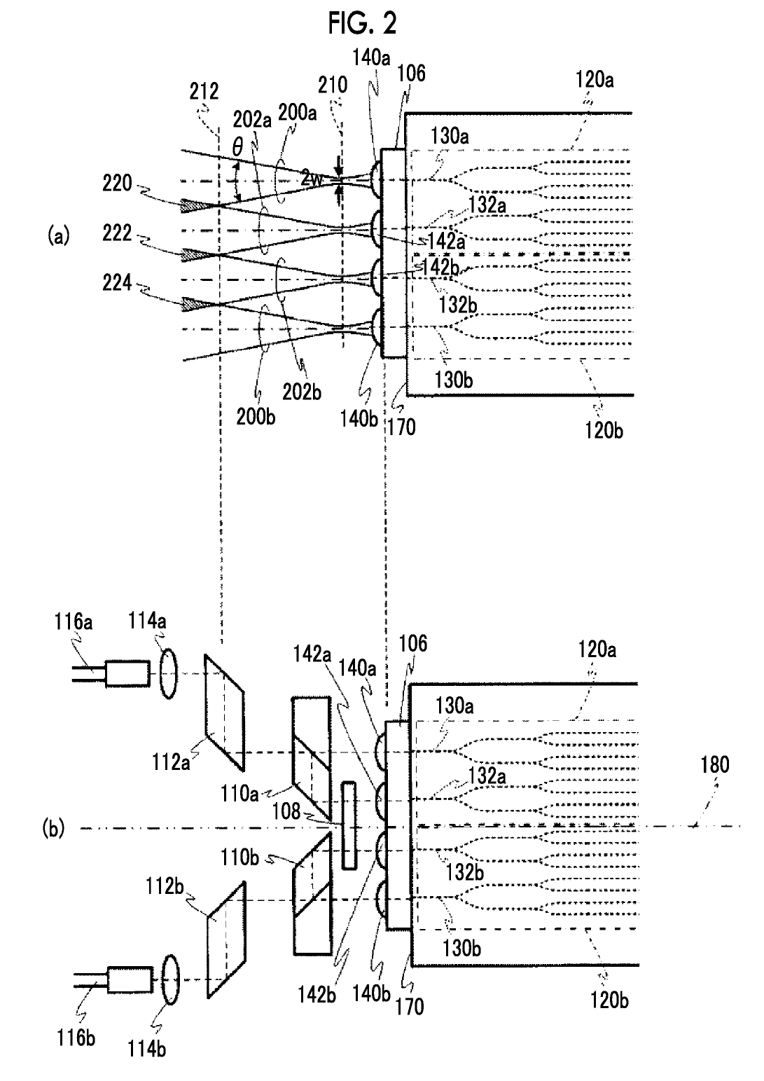

(a) and (b) of FIG. 2 respectively illustrate partial detail views of the periphery of the microlens array 106 in the optical modulation device 100 illustrated in FIG. 1. Specifically, (a) of FIG. 2 schematically illustrates a state in which the resultant light beams are overlapped with each other in a case where the four light beams output from the optical modulation elements 120a and 120b of the optical modulation device 100 illustrated in FIG. 1 are respectively collimated by the four microlenses 140a, 142a, 140b, and 142b and the resultant light beams go directly. In (a) of FIG. 2, for convenience of illustrating that the collimated light beam diverges, a divergence angle degree of the collimated light beam is larger than the divergence angle degree actually is.

Respective collimated light beams 200a, 202a, 202b, and 200b output from the output waveguides 130a and 132a, 132b, 130b of the optical modulation elements 120a and 120b and collimated by the four microlenses 140a, 142a, 142b, and 140b are respectively output from the microlenses 140a, 142a, 142b, and 140b while holding Gaussian shapes.

The collimated light beams 200a, 202a, 202b, and 200b are output from the microlenses 140a, 142a, 142b, and 140b and have beam waists respectively having minimum beam diameters at a position 210 at which the collimated light beams are propagated up to a certain distance. If the collimated light beams exceed the position 210 of the beam waist, the collimated light beams 200a, 202a, 202b, and 200b are respectively propagated by a divergence angle θ in the left direction in the drawing while widening the beam diameter and parts of the beams adjacent each other are started to overlap with each other at a position 212. In (a) of FIG. 2, on the left side in the drawing than the position 212 at which the beams are started to overlap each other, an area in which parts of the collimated light beams 200a and 202a output from the microlenses 140a and 142a overlap with each other is illustrated as a hatching area to which a reference numeral 220 is attached. In addition, an area in which parts of the collimated light beams 202a and 202b output from the microlenses 142a and 142b overlap with each other is illustrated as a hatching area to which a reference numeral 222 is attached. Further, an area in which parts of the collimated light beams 202b and 200b output from the microlenses 142b and 140b overlap with each other is illustrated as a hatching area to which a reference numeral 224 is attached.

In general, a polarization beam combining prism includes a polarization-beam-combining film on one optical surface. The two linearly polarized light beams independently (without overlapping) and orthogonaly propagated to each other are respectively input to one surface or another surface of the polarization-beam-combining film.

One linearly polarized light beam transmit into the polarization-beam-combining film and the other linearly polarized light beam reflects on the polarization-beam-combining film.

Accordingly, the transmitted and reflected light beam becomes one beam (polarization-beam-combined beam).

In a case where parts of the two linearly polarized light beams in the polarization directions orthogonal to each other overlap each other, the overlapping portion is input from any one of surfaces of the polarization-beam-combining film constituting the polarization beam combining prism. That is, the linearly polarized light beam in a polarized wave direction not required for the polarization-beam-combining is input to the respective surfaces of the polarization-beam-combining film. The linearly polarized light beam in the polarized wave direction not required for the polarization-beam-combining is not polarization-beam-combined in a desired direction (out of an optical axis of the polarization-beam-combined beam), so that the linearly polarized light beam becomes a loss.

In the optical modulation device 100 according to the present embodiment, as illustrated in (b) of FIG. 2, the light beams respectively output from the microlenses 140a, 142a, 140b, and 142b do not pass through another optical component such as an optical path shift prism which extends the optical path length of the light beam but are directly input to the half-wavelength plate 108 and/or the polarization beam combining prisms 110a and 110b firstly. Here, “optical path shift prism” means a prism (that is, polyhedron including a transparent medium such as glass having a refractive index higher than the surroundings) which moves the optical path in a direction orthogonal to the optical path.

Accordingly, the half-wavelength plate 108 and the polarization beam combining prisms 110a and 110b can be disposed between the position 212 at which the light beams respectively output from the microlenses 140a, 142a, 142b, and 140b as collimated light beams overlap with each other by the divergence angle of the collimated light beam and a position at which the four microlenses 140a, 142a, 142b, and 140b are disposed.

For this reason, in the optical modulation device 100 of the present embodiment, even in a case where the divergence angle of the collimated light beam output from the microlenses 140a, 142a, 140b, and 142b is large, the beams do not overlap with each other. It is possible to reduce the optical loss from the input optical fibers 104a and 104b to the output optical fibers 116a and 116b by performing the polarization-beam-combining with less loss.

In the present embodiment, another optical component such as an optical path shift prism or the like is not disposed in a space between the microlenses 140a, 142a, 140b, and 142b and the half-wavelength plate 108 and/or the polarization beam combining prisms 110a and 110b. However, the present embodiment is not limited thereto. As long as not significantly extending the optical path length in the space, for example, an optical component including another optical component other than the optical path shift prism, for example, a parallel flat plate (That is, front and back surfaces are parallel to each other) of an optical medium such as glass may be inserted into the space. The optical component including this parallel flat plate may be may be, for example, an optical path length adjustment element or a wavelength filter element provided with a dielectric multilayer film (nonreflective coating, filter film (for example, low-pass filter, high-pass filter, and band-pass filter), or the like) on the surface of the parallel flat plate.

In addition, in the optical modulation device 100 of the present embodiment, since the output light beams adjacent with each other and respectively output from the microlenses 142a and 142b are input to the half-wavelength plate 108 before an interval between the output light beams is widened by the optical path shift prism or the like, it is possible to rotate wavelengths of two light beams by using the half-wavelength plate 108 as one optical element. For this reason, as compared with a configuration in which the half-wavelength plate is provided for each of the output light beams, it is possible to reduce the number of optical elements, and it is possible to improve stability of an optical system and to reduce assembly processes.

In addition, the optical paths of the light beams output from the polarization beam combining prisms 110a and 110b are shifted in the directions away from each other by the optical path shift prisms 112a and 112b. For this reason, even in a case where focal distances of the microlenses 140a, 142a, 140b, and 142b decrease and the divergence angle of the collimated light beam increases, so that the beam diameter of the light beam which reaches the coupling lenses 114a and 114b increases, it is possible to secure a space in which the coupling lenses 114a and 114b having large opening areas (or light receiving areas) according to the beam diameter are disposed and it is possible to increase a degree of freedom in designing.

Further, in the optical modulation device 100 of the present embodiment, the optical modulation element 120a and the optical modulation element 120b are disposed at positions line-symmetrical with respect to the line segment 180 parallel to directions of the output light beams of the optical modulation elements 120a and 120b and the polarization beam combining prisms 110a and 110b are also disposed at positions line-symmetrical with respect to the line segment 180.

For this reason, for example, the polarization beam combining prisms 110a and 110b can also be configured as one optical element having a line-symmetrical shape. In this case, it is possible to further reduce the number of the optical elements used in the housing 118, and it is possible to further improve the stability of the optical system and to reduce the assembly processes.

In addition, in the optical modulation device 100 of the present embodiment, the optical path shift prisms 112a and 112b, the coupling lenses 114a and 114b, and the output optical fibers 116a and 116b are also disposed at positions symmetrical with respect to the line segment 180 from one another.

Accordingly, the optical system from the input optical fiber 104a to the output optical fiber 116a and the optical system from the input optical fiber 104b to the output optical fiber 116b are symmetrical with respect to the line segment 180 from each other.

Generally, in a rectangular housing such as the housing 118 illustrated in FIG. 1, a distortion occurring at environmental temperature variation has geometrically approximate symmetry. For this reason, since the optical system from the input optical fiber 104a to the output optical fiber 116a and the optical system from the input optical fiber 104b to the output optical fiber 116b are symmetrical with respect to the line segment 180 from each other, it is possible to make characteristic changes such as positional deviation amount of the optical element in each of the optical systems at the environmental temperature variation, a refractive index change according to the distortion of each of the optical components which occur at the environmental temperature variation, an operation point shift of the optical modulation device, or the like be comparable degrees.

As a result, for example, in a case where two light beams included in two wavelength channels of a wavelength multiplex transmission system are modulated by the optical modulation device 100, it is possible to make changes, according to the environmental temperature variation, of an optical loss (transmission loss or insertion loss, the same below) from the input optical fiber 104a to the output optical fiber 116a and an optical loss from the input optical fiber 104b to the output optical fiber 116b be comparable degrees. Accordingly, it is possible to prevent a loss difference between the wavelength channels according to the environmental temperature variation from occurring or increasing (accordingly, to prevent a level difference of the transmission light beams between the wavelength channels in the wavelength multiplex system from occurring or increasing) and to prevent a disparity of a transmission quality between the channels from occurring or increasing.

In the first embodiment described above, as an optical modulator, the two optical modulation elements 120a and 120b use one optical modulator 102 formed on one sheet of the substrate, but the first embodiment is not limited thereto. Two optical modulators including one optical modulation element formed on the each separate substrate may be used.

In addition, in the first embodiment described above, by using the polarization beam combining prisms 110a and 110b, the polarization-beam-combining is performed, but the first embodiment is not limited thereto. As long as two linearly polarized light beams polarized in the same direction can be polarization-beam-combined, for example, by using a predetermined configuration of using a birefringent crystal or the like instead of the polarization beam combining prism, the polarization-beam-combining may be performed.

### Second Embodiment

Next, the second embodiment of the present invention will be described.

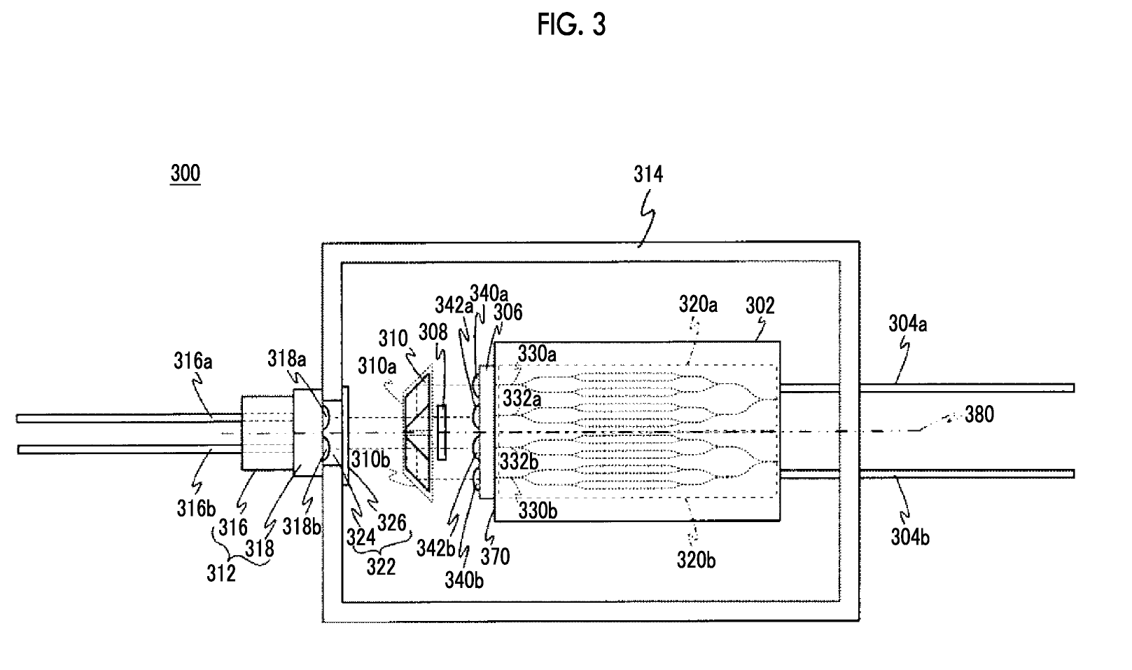

FIG. 3 is a view illustrating a configuration of an optical modulation device according to the present embodiment. An optical modulation device 300 includes an optical modulator 302, input optical fibers 304a and 304b which are optical fibers through which a light beam from a light source (not illustrated) is input to the optical modulator 302, an output microlens array 306, a half-wavelength plate 308, a polarization beam combining prism 310, a fiber coupling assembly 312, and a housing 314 which accommodates optical components.

For example, the input optical fibers 304a and 304b allow linearly polarized light beams, which are transmitted from two light sources (not illustrated) and have wavelengths different from each other, to be input to the optical modulator 302.

The optical modulator 302 includes two optical modulation elements 320a and 320b which are formed on one sheet of LN substrate and include optical waveguides. For example, the optical modulation elements 320a and 320b are optical modulation elements which perform DP-QPSK modulation or DP-QAM modulation.

As illustrated in FIG. 3, the optical modulation elements 320a and 320b are disposed so that the output light beams are output side by side. That is, in FIG. 3, the optical modulation elements 320a and 320b are disposed so that all of the output light beams of the optical modulation elements 320a and 320b are output from a substrate end surface 370 on the left side in the drawing of the optical modulator 302 in the left direction side by side in the vertical direction in the drawing. In addition, the present embodiment, the optical modulation elements 320a and 320b are disposed at positions which are line-symmetrical with respect to the line segment 180 parallel to the directions of the output light beams output side by side.

In the present embodiment, the optical modulation elements 320a and 320b are disposed so that all of the output light beams output from the optical modulation elements 320a and 320b are output side by side in a linear shape in the vertical direction in FIG. 3, but the present embodiment is not limited thereto. As long as the output light beams are output “side by side”, the output light beams of the optical modulation elements 320a and 320b may be disposed so that the output light beams have predetermined positional relationship with one another. For example, the optical modulation elements 320a and 320b also may be disposed so that output end surfaces (left side end surfaces illustrated in FIG. 3) of the respective light beams of the optical modulation elements 320a and 320b are disposed to be displaced from each other by a prescribed distance in the left-right direction in FIG. 3. In addition, for example, the output light beams of the optical modulation elements 320a and 320b may be disposed so that output points of the respective light beams from the optical modulation elements 320a and 320b are different from one another in the substrate thickness direction (direction perpendicular to the page of FIG. 3) of the optical modulation elements 320a and 320b.

The optical modulation element 320a is a first optical modulation element. The linearly polarized light beam input from the input optical fiber 304a is branched into two light beams and modulated by electronic signals different from each other, and respectively output from output waveguides 330a and 332a. In addition, the optical modulation element 320b is a second optical modulation element. The linearly polarized light beam input from the input optical fiber 304b is branched into two light beams and modulated by electronic signals different from each other, and respectively output from output waveguides 330b and 332b.

The output microlens array 306 formed by four microlenses 340a, 342a, 340b, and 342b, which are four output lenses, is disposed on the substrate end surface 370 (substrate end surface on a side (that is, left side in the drawing) on which output waveguides 330a, 332a, 330b, and 332b are formed) on a light beam output side of the optical modulator 302.

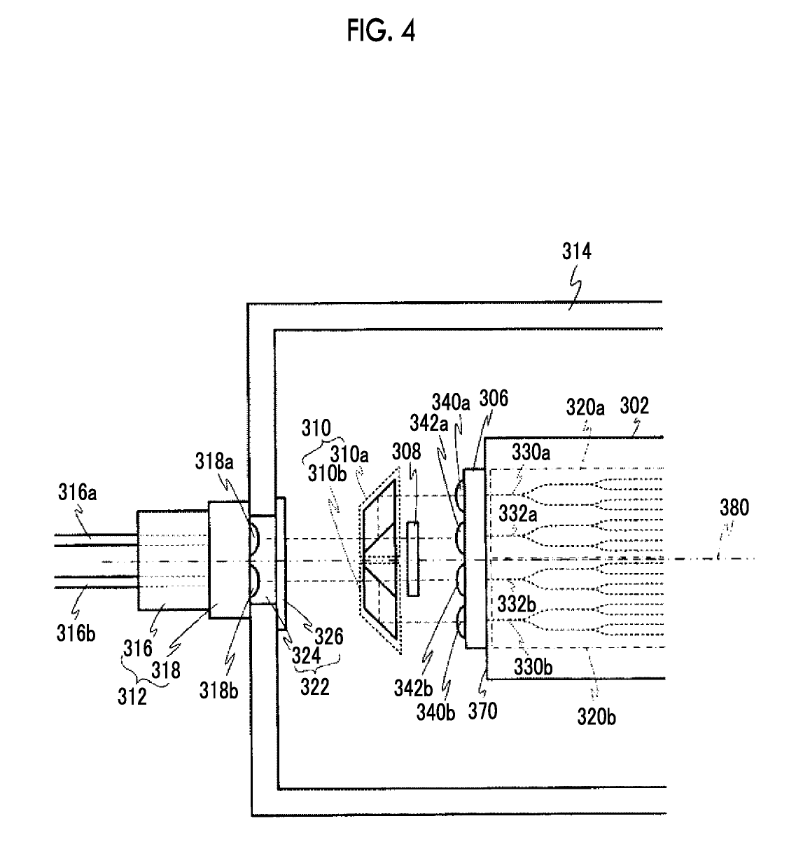

FIG. 4 is a partial detail view of the periphery of the output microlens array 306 in the optical modulation device 300 illustrated in FIG. 3.

The light beams output from the output waveguides 330a and 332a of the optical modulation element 320a are input to the microlenses 340a and 342a and the light beams output from the output waveguides 330b and 332b of the optical modulation element 320b are input to the microlenses 340b and 342b. The light beams input to the microlenses 340a, 342a, 340b, and 342b respectively become, for example, the parallel light beam by being collimated (collimated light beam) and the resultant light beams are output.

The light beam, which is one output light beam output from the optical modulation element 320a, output from the output waveguide 332a and the light beam, which is one output light beam output from the optical modulation element 320b, output from the output waveguide 332b respectively pass through the microlenses 342a and 342b, after then, the light beams are input to the half-wavelength plate 308 together. The half-wavelength plate 308 is a polarization rotation element. When the output light beams, which are the two linearly polarized light beams input to the half-wavelength plate 308, pass through the half-wavelength plate 308, a polarized wave of each of the output light beams is rotated by 90°. In the present description, the half-wavelength plate 308 is set to be one for the two output light beams, but the half-wavelength plate 308 may be set to be one for each of the two output light beams. However, it is possible to reduce the number of components, reduce assembly processes, and improve reliability by setting the half-wavelength plate 308 to be one for the two output light beams.

Accordingly, the light beam, which is one output light beam output from the optical modulation element 320a, output from the output waveguide 332a and the light beam, which is another output light beam output from the optical modulation element 320a, output from the output waveguide 330a become the linearly polarized light beams in the polarized wave directions orthogonal to each other and are input to the polarization beam combining prism 310. In the same manner, the light beam, which is one output light beam output from the optical modulation element 320b, output from the output waveguide 332b and the light beam, which is another output light beam, output from the output waveguide 330b become the linearly polarized light beams in the polarized wave directions orthogonal to each other and are input to the polarization beam combining prism 310.

Here, since wavelengths of the light beams respectively input to the input optical fibers 304a and 304b are different from each other, in a case where the wavelength of the light beam output from the output waveguide 332a of the optical modulation element 320a and the wavelength of the light beam output from the output waveguide 332b of the optical modulation element 320b are different from each other (or as necessary), in the half-wavelength plate 308, an optical thickness of an area through which the light beam output from the output waveguide 332a of the optical modulation element 320a passes and an optical thickness of an area through which the light beam output from the output waveguide 332b of the optical modulation element 320b passes may be set to be different from each other according to wavelengths of the optical thicknesses.

For example, in the half-wavelength plate 308, the half-wavelength plate 308 is disposed so that the area through which the light beam output from the output waveguide 332a of the optical modulation element 320a passes and the area through which the light beam output from the output waveguide 332b of the optical modulation element 320b passes are line-symmetrical with respect to the line segment 180. The half-wavelength plate 308 having each of the areas may be configured by one half-wavelength plate. In addition, the half-wavelength plates having the respective areas may be prepared and separately disposed, or may be combined into one.

The polarization beam combining prism 310 is formed by integrating two polarization beam combining prisms and includes a polarization beam combining prism unit 310a and a polarization beam combining prism unit 310b. The polarization beam combining prism unit 310a is the first polarization beam combining element and combines the two linearly polarized light beams output from the optical modulation element 320a in the polarization directions orthogonal to each other, into one beam and outputs the resultant beam. In addition, the polarization beam combining prism unit 310b is the second polarization beam combining element and combines the two linearly polarized light beams output from the optical modulation element 320b in the polarization directions orthogonal to each other, into one beam and outputs the resultant beam.

Here, the polarization beam combining prism units 310a and 310b respectively allow one of the two input linearly polarized light beams to pass through without changing the propagation direction, and respectively shift an optical axis of another linearly polarized light beam having the optical axis parallel to an optical axis of the one linearly polarized light beam while maintaining the optical axis direction and allow the optical axis of another linearly polarized light beam to align with the optical axis of the one linearly polarized light beam to output one polarization-beam-combined beam.

In the present embodiment, the polarization beam combining prism 310 shifts the optical axes of the two output light beams (that is, output light beams output from the output waveguides 330a and 330b) at the outermost of rows of the four output light beams side by side output from the optical modulation elements 320a and 320b while maintaining the optical axis direction. Then, the optical axes of the two output light beams are aligned to optical axes of the two output light beams (that is, output light beams output from the output waveguides 332a and 332b) at the inside of rows of the four output light beams side by side output so that two polarization-beam-combined beams are output.

Therefore, in the present embodiment, an interval between the optical axes of the two polarization-beam-combined beams output from the polarization beam combining prism 310 is equal to an interval (therefore, interval between output waveguides 332a and 332b) between the optical axes of the two output light beams at the inside of the rows of the four output light beams side by side output from the optical modulation elements 320a and 320b.

Further, for example, a polarization beam combining prism 310 is configured and/or disposed so that the polarization beam combining prism units 310a and 310b are line-symmetrical with respect to the line segment 180.

The fiber coupling assembly 312 includes a fiber array 316 and a coupling microlens array 318. The fiber array 316 includes two output optical fibers 316a and 316b. The coupling microlens array 318 includes two microlenses 318a and 318b which are coupling lenses.

In the housing 314, a window 322 for output beams respectively output from the polarization beam combining prism units 310a and 310b of the polarization beam combining prism 310 to the outside of the housing 314 is provided. The fiber coupling assembly 312 including the fiber array 316 and the coupling microlens array 318 is provided at a position at which the beams can be received via the window 322, on an outer surface of the housing 314. Here, for example, the window 322 includes a hole 324 provided at the housing 314 and transparent glass 326 disposed to close the hole 324. The transparent glass 326 is, for example, sapphire glass and is hermetically fixed to an inner surface of the housing 314, for example, by brazing.

Accordingly, after the beams output from the polarization beam combining prism unit 310a pass through the window 322, the beams are collected by the microlens 318a, are input to the output optical fiber 316a, and are output from the optical modulation device 300. In the same manner, after the beams output from the polarization beam combining prism unit 310b pass through the window 322, the beams are collected by the microlens 318b, are input to the output optical fiber 316b, and are output from the optical modulation device 300.

Here, the fiber array 316 of the fiber coupling assembly 312 allows an interval between the optical axes, in respective ends, of the output optical fibers 316a and 316b to coincide with an interval between the respective optical axes of the two beams (that is, beam output from polarization beam combining prism unit 310a and beam output from polarization beam combining prism unit 310b) output from the polarization beam combining prism 310. According to this configuration, since the beams output from the polarization beam combining prism unit 310a and the polarization beam combining prism unit 310b do not pass through an optical component for adjusting the interval between the optical axes after the output, it is possible to increase coupling efficiency for the output optical fibers 316a and 316a and to reduce a propagation loss of the beams.

The fiber coupling assembly 312 is disposed so that the output optical fibers 316a and 316b included in the fiber array 316 are line-symmetrical with respect to the line segment 180 and the two microlenses 318a and 318b included in the coupling microlens array 318 are line-symmetrical with respect to the line segment 180. The output optical fibers 316a and 316b respectively correspond to a first optical fiber and a second optical fiber which respectively receive the beams output from the polarization beam combining prism units 310a and 310b which are polarization beam combining elements.

As described above, the interval between the optical axes of the two beams output from the polarization beam combining prism 310 is equal to the interval between the optical axes of the two output light beams (therefore, output light beams from output waveguides 332a and 332b) at the inside of the rows of the four output light beams side by side output from the optical modulation elements 320a and 320b. Therefore, the interval between the optical axes, in respective ends, of the output optical fibers 316a and 316b included in the fiber array 316 is also equal to the interval between the optical axes of the output light beams output from the output waveguides 332a and 332b.

According to this configuration, after the light beams input from the input optical fiber 304a are modulated by the optical modulation element 320a, the resultant light beams are polarization-beam-combined by the half-wavelength plate 308 and the polarization beam combining prism unit 310a and output from the output optical fiber 316a. In addition, in the same manner, after the light beams input from the input optical fiber 304b are modulated by the optical modulation element 320b, the resultant light beams are polarization-beam-combined by the half-wavelength plate 308 and the polarization beam combining prism unit 310b and output from the output optical fiber 316b.

Specifically, in the optical modulation device 300 according to the present embodiment, as described above, the interval between the two polarization-beam-combined beams is equal to the interval between the two polarization-beam-combined beams is equal to the interval between the two output light beams (that is, output light beams from output waveguides 332a and 332b) at the inside among the rows of the four output light beams side by side output from the optical modulation elements 320a and 320b.

The two beams is coupled and output to the output optical fibers 316a and 316b included in the fiber array 316.

For this reason, in the present optical modulation device 300, it is not necessary to use a prism for optical path shift in the related art and it is possible to reduce the number of optical components. Therefore, it is possible to seek an improvement and stabilization of optical characteristics (variation with environmental temperature or the like) of optical characteristics such as a transmission loss (that is, insertion loss of optical modulation device 300) of the light beam and it is possible to miniaturize the housing 314 and to reduce a material cost, an assembly cost, or the like.

In the present embodiment, the polarization beam combining prism 310 allows the interval between the two beams output from the polarization beam combining prism 310 to coincide with the interval between the two output light beams (that is, output light beams output from output waveguides 332a and 332b) at the inside among the rows of the four output light beams side by side output from the optical modulation elements 320a and 320b. However, the configuration of the polarization beam combining prism 310 is not limited thereto. For example, the interval between the beams respectively output from the polarization beam combining prism units 310a and 310b may be narrower than the interval (hereinafter, referred to as “interval L”) between the two output light beams (that is, output light beams output from output waveguides 330a and 330b) at the outermost of the rows of the four output light beams side by side output from the optical modulation elements 320a and 320b.

In this case, since the polarization beam combining prism unit does not largely protrude than a width of the LN substrate and is not occupied unlike the related art, it is possible to miniaturize the optical modulation device. In addition, the polarization beam combining prism units 310a and 310b are disposed to be smaller than the width of the LN substrate, in this case, it is possible to further miniaturize the optical modulation device. Further, since the polarization beam combining prism 310 includes the two polarization beam combining prisms as one unit, the polarization beam combining prism 310 can be disposed in a narrow range and contributes to miniaturization as compared with a configuration in the related art, in which the polarization beam combining prisms are discretely disposed in a wide range.

Further, in the optical modulation device 300 of the present embodiment, the optical modulation elements 320a and 320b and the polarization beam combining prism units 310a and 310b, which are primary factors for determining optical path disposition inside the housing 314, are respectively disposed to be line-symmetrical with respect to the line segment 180 parallel to the directions of the output light beams of the optical modulation elements 320a and 320b.

Generally, in a rectangular housing such as the housing 314 illustrated in FIG. 3, a distortion occurring at environmental temperature variation has geometrically approximate symmetry. For this reason, since the optical system from the input optical fiber 304a to the output optical fiber 316a and the optical system from the input optical fiber 304b to the output optical fiber 316b are symmetrical with respect to the line segment 180 from each other, it is possible to make comparable degrees of positional deviation amount of the optical element in each of the optical systems at the environmental temperature variation.

As a result, for example, in a case where two light beams included in two wavelength channels of a wavelength multiplex transmission system are modulated by the optical modulation device 300, it is possible to make changes, according to the environmental temperature variation, of an optical loss (transmission loss or insertion loss, the same below) from the input optical fiber 304a to the output optical fiber 316a and an optical loss from the input optical fiber 304b to the output optical fiber 316b be comparable degrees. Accordingly, it is possible to prevent a loss difference between the wavelength channels according to the environmental temperature variation from occurring or increasing (accordingly, to prevent a level difference of the transmission light beams between the wavelength channels in the wavelength multiplex system from occurring or increasing) and to prevent a disparity of a transmission quality between the channels from occurring or increasing.

Further, in the optical modulation device 300 according to the present embodiment, the interval between the two beams output from the polarization beam combining prism 310 and the interval between the optical axes of the output optical fibers 316a and 316b are set to be narrower than the interval between the output waveguides 332a and 332b of the optical modulation element 320a and the optical modulation element 320b by a comparable degree, it is possible to guide the two beams output from the polarization beam combining prism 310 to the outside of the housing 314 via one window 322 provided in the housing 314.

For this reason, in the optical modulation device 300, it is possible to reduce variation of the optical loss by reducing the distortion occurring at the environmental temperature variation of the housing 314 as compared with the related art in which two holes (or windows) for guiding the output light beam (output optical fiber) to the outside of the housing are provided in the housing. Furthermore, for example, by reducing the distortion of the housing 314 occurring when a cover is hermetically sealed with the housing 314 by being pressed and melted, it is possible to reduce variation of the optical loss before and after being hermetically sealed.

In the second embodiment described above, as an optical modulator, the two optical modulation elements 320a and 320b use one optical modulator 302 formed on one sheet of the substrate, but the second embodiment is not limited thereto. Two optical modulators including one optical modulation element formed on the each separate substrate may be used.

### Third Embodiment

Next, the third embodiment of the present invention will be described.

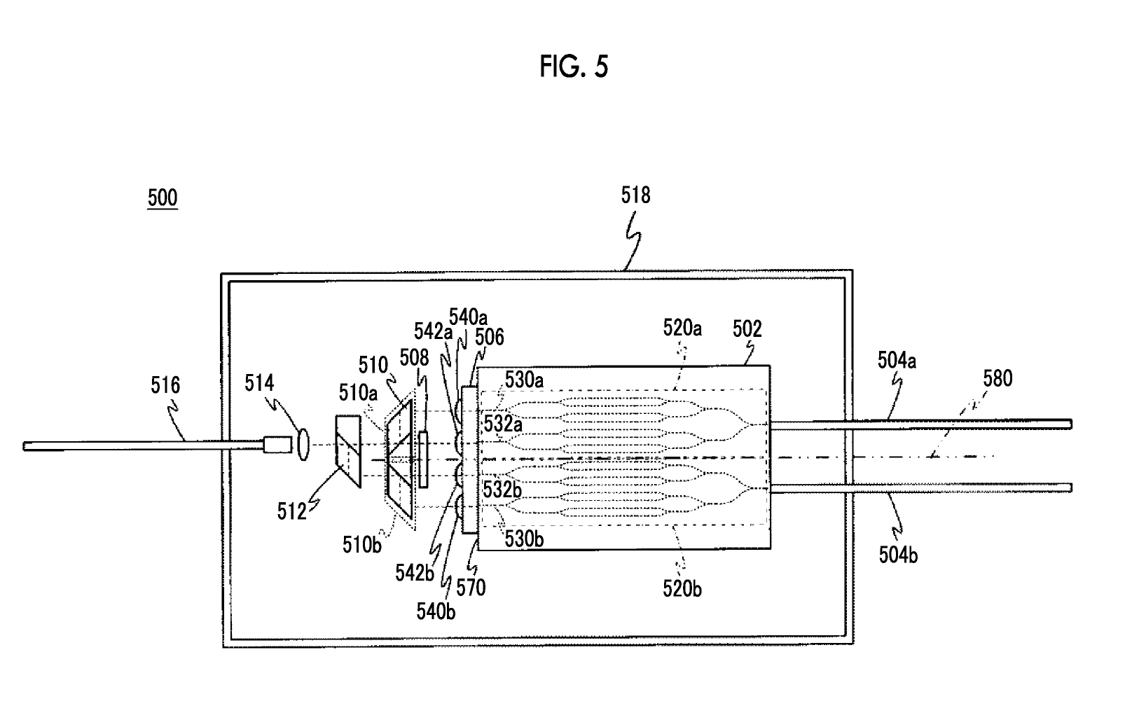

FIG. 5 is a view illustrating a configuration of an optical modulation device according to the third embodiment of the invention. An optical modulation device 500 includes an optical modulator 502, input optical fibers 504a and 504b which are optical fibers through which a light beam from a light source (not illustrated) is input to the optical modulator 502, an output microlens array 506, a half-wavelength plate 508, a polarization beam combining prism 510, a wavelength combining prism 512, a coupling lens 514, an output optical fiber 516, and a housing 518.

The input optical fibers 504a and 504b allow linearly polarized light beams, which are transmitted from two light sources (not illustrated) and have wavelengths different from each other, to be input to the optical modulator 502.

The optical modulator 502 includes two optical modulation elements 520a and 520b which are formed on one sheet of LN substrate and include optical waveguides. For example, the optical modulation elements 520a and 520b are optical modulation elements which perform DP-QPSK modulation or DP-QAM modulation.

As illustrated in FIG. 5, the optical modulation elements 520a and 520b are disposed so that the output light beams are output side by side. That is, in FIG. 5, the optical modulation elements 520a and 520b are disposed so that all of the output light beams of the optical modulation elements 520a and 520b are output from a substrate end surface 570 on the left side in the drawing of the optical modulator 502 in the left direction side by side in the vertical direction in the drawing. In addition, the present embodiment, the optical modulation elements 520a and 520b are disposed at positions which are line-symmetrical with respect to the line segment 180 parallel to the directions of the output light beams output side by side.

In the present embodiment, the optical modulation elements 520a and 520b are disposed so that all of the output light beams output from the optical modulation elements 520a and 520b are output side by side in a linear shape in the vertical direction in FIG. 5, but the present embodiment is not limited thereto. As long as the output light beams are output “side by side”, the output light beams of the optical modulation elements 520a and 520b may be disposed so that the output light beams have predetermined positional relationship with one another. For example, the optical modulation elements 520a and 520b also may be disposed so that output end surfaces (left side end surfaces illustrated in FIG. 5) of the respective light beams of the optical modulation elements 520a and 520b are disposed to be displaced from each other by a prescribed distance in the left-right direction in FIG. 5. In addition, for example, the output light beams of the optical modulation elements 520a and 520b may be disposed so that output points of the respective light beams from the optical modulation elements 520a and 520b are different from one another in the substrate thickness direction (direction perpendicular to the page of FIG. 5) of the optical modulation elements 520a and 520b.

The optical modulation element 520a is a first optical modulation element. The linearly polarized light beam input from the input optical fiber 504a is branched into two light beams and modulated by electronic signals different from each other, and respectively output from output waveguides 530a and 532a. In addition, the optical modulation element 520b is a second optical modulation element. The linearly polarized light beam input from the input optical fiber 504b is branched into two light beams and modulated by electronic signals different from each other, and respectively output from output waveguides 530b and 532b.

The output microlens array 506 formed by four microlenses 540a, 542a, 540b, and 542b, which are four output lenses, is disposed on the substrate end surface 570 (substrate end surface on a side (that is, left side in the drawing) on which output waveguides 530a, 532a, 530b, and 532b are formed) on a light beam output side of the optical modulator 502.

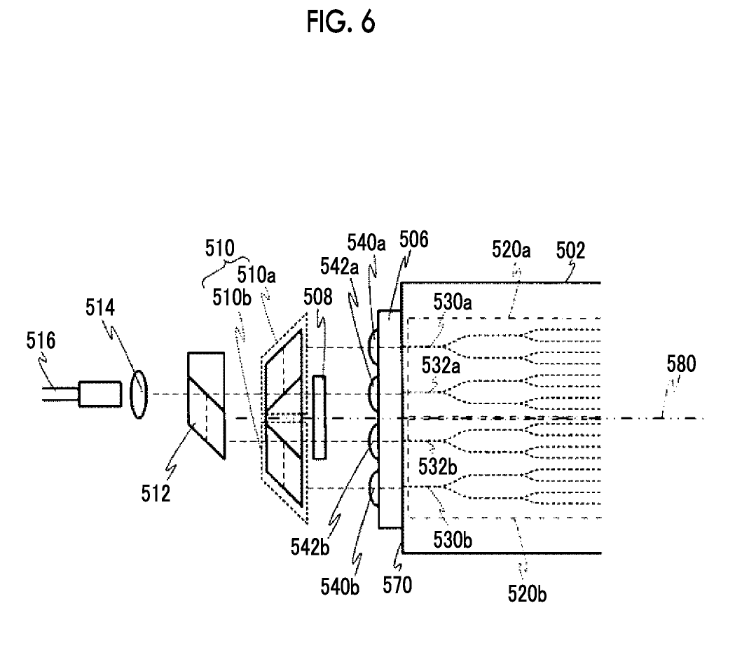

FIG. 6 is a partial detail view of the periphery of the output microlens array 506 in the optical modulation device 500 illustrated in FIG. 5.

The light beams output from the output waveguides 530a and 532a of the optical modulation element 520a are input to the microlenses 540a and 542a and the light beams output from the output waveguides 530b and 532b of the optical modulation element 520b are input to the microlenses 540b and 542b. The light beams input to the microlenses 540a, 542a, 540b, and 542b respectively become, for example, the parallel light beam by being collimated (collimated light beam) and the resultant light beams are output.

The light beam, which is one output light beam output from the optical modulation element 520a, output from the output waveguide 532a and the light beam, which is one output light beam output from the optical modulation element 520b, output from the output waveguide 532b respectively pass through the microlenses 542a and 542b, after then, the light beams are input to the half-wavelength plate 508 together. The half-wavelength plate 508 is a polarization rotation element. When the output light beams, which are the two linearly polarized light beams input to the half-wavelength plate 508 pass through the half-wavelength plate 508, a polarized wave of each of the output light beams is rotated by 90°.

Accordingly, the light beam, which is one output light beam output from the optical modulation element 520a, output from the output waveguide 532a and the light beam, which is another output light beam output from the optical modulation element 520a, output from the output waveguide 530a become the linearly polarized light beams in the polarized wave directions orthogonal to each other and are input to the polarization beam combining prism 510. In the same manner, the light beam, which is one output light beam output from the optical modulation element 520b, output from the output waveguide 532b and the light beam, which is another output light beam, output from the output waveguide 530b become the linearly polarized light beams in the polarized wave directions orthogonal to each other and are input to the polarization beam combining prism 510.

Here, the half-wavelength plate 508 may have an optical thickness of an area through which the light beam output from the output waveguide 532a of the optical modulation element 520a passes and an optical thickness of an area through which the light beam output from the output waveguide 532b of the optical modulation element 520b passes, different from each other according to wavelengths of the optical thicknesses.

For example, the half-wavelength plate 508 is disposed so that the area through which the light beam output from the output waveguide 532a of the optical modulation element 520a passes and the area through which the light beam output from the output waveguide 532b of the optical modulation element 520b passes, included in the half-wavelength plate 508, are line-symmetrical with respect to the line segment 180.

The polarization beam combining prism 510 is formed by integrating two polarization beam combining prisms and includes a polarization beam combining prism unit 510a and a polarization beam combining prism unit 510b. The polarization beam combining prism unit 510a is the first polarization beam combining element and combines the two linearly polarized light beams output from the optical modulation element 520a in the polarization directions orthogonal to each other, into one beam and outputs the resultant beam. In addition, the polarization beam combining prism unit 510b is the second polarization beam combining element and combines the two linearly polarized light beams output from the optical modulation element 520b in the polarization directions orthogonal to each other, into one beam and outputs the resultant beam.

Here, the polarization beam combining prism units 510a and 510b respectively allow one of the two input linearly polarized light beams to pass through without changing the propagation direction, and respectively shift an optical axis of another linearly polarized light beam having the optical axis parallel to an optical axis of the one linearly polarized light beam while maintaining the optical axis direction and allow the optical axis to align with the optical axis of the one linearly polarized light beam to output one polarization-beam-combined beam.

In the present embodiment, the polarization beam combining prism 510 shifts the optical axes of the two output light beams (that is, output light beams output from the output waveguides 530a and 530b) at the outermost of rows of the four output light beams side by side output from the optical modulation elements 520a and 520b while maintaining the optical axis direction. Then, the optical axes of the two output light beams are aligned to optical axes of the two output light beams (that is, output light beams output from the output waveguides 532a and 532b) at the inside of rows of the four output light beams side by side output so that two polarization-beam-combined beams are output. Therefore, in the present embodiment, an interval between the optical axes of the two polarization-beam-combined beams output from the polarization beam combining prism 510 is equal to an interval (therefore, interval between output waveguides 532a and 532b) between the optical axes of the two output light beams at the inside of the rows of the four output light beams side by side output from the optical modulation elements 520a and 520b.

In addition, for example, the polarization beam combining prism 510 is disposed so that the polarization beam combining prism units 510a and 510b are line-symmetrical with respect to the line segment 180.

The wavelength combining prism 512 is a wavelength combining element and by using a wavelength difference between the two beams output from the polarization beam combining prism units 510a and 510b, wavelength-combines the two beams and outputs the resultant light beam as one output light beam.

The coupling lens 514 allows the output light beams output from the wavelength combining prism 512 to be input to the output optical fiber 516. The light beam input to the output optical fiber 516 is guided to the outside of the housing 518 by the output optical fiber 516.

The housing 518 is made of, for example, metal (aluminum, stainless steel, or the like) and accommodates the optical modulator 502, the output microlens array 506, the half-wavelength plate 508, the polarization beam combining prism 510, the wavelength combining prism 512, the coupling lens 514, and the like.

According to this configuration, the light beams having respectively different wavelengths respectively input from the input optical fibers 504a and 504b are respectively modulated by the optical modulation elements 520a and 520b, and are respectively polarization-beam-combined by the polarization beam combining prism units 510a and 510b and wavelength-combined by the wavelength combining prism 512, and then the resultant light beam is output from the output optical fiber 516 as one output light beam.

Specifically, since the optical modulation device 500 has a function of wavelength combining in which two light beams, input from the input optical fibers 504a and 504b and modulated by the optical modulation elements 520a and 520b, having different wavelengths are wavelength-combined inside the optical modulation device 500 and output as one output light beam, it is not necessary to perform the wavelength combining outside the optical modulation device in the related art.

In addition, in the optical modulation device 500 according to the present embodiment, as described above, the interval between the two polarization-beam-combined beams is equal to the interval between the two output light beams (that is, output light beams output from output waveguides 532a and 532b) at the inside of the rows of the four output light beams side by side output from the optical modulation elements 520a and 520b (that is, output light beams from output waveguides 532a and 532b respectively go directly and pass permeate through polarization beam combining prism units 510a and 510b). For this reason, a size of the wavelength combining prism 512 can be reduced to a comparable degree with the interval between the output waveguides 532a and 532b.

That is, in the optical modulation device 500, since the wavelength combining is performed by preparing another wavelength combining element unlike an optical modulation device in the related art, it is possible to reduce an optical loss (optical loss of light beam output from two light sources having different output light waves and coupled to the output optical fiber 516 which outputs the wavelength combining the light beam), to seek stabilization (stabilization of variation with environmental temperature or the like) of optical characteristics such as the optical loss or the like, and to miniaturize the housing 518 and to reduce a material cost, an assembly cost, and the like.

In the present embodiment, the polarization beam combining prism 510 allows the interval between the two beams output from the polarization beam combining prism 510 to coincide with the interval between the two output light beams (that is, output light beams output from output waveguides 532a and 532b) at the inside among the rows of the four output light beams side by side output from the optical modulation elements 520a and 520b. However, the configuration of the polarization beam combining prism 510 is not limited thereto. For example, the interval between the beams respectively output from the polarization beam combining prism units 510a and 510b may be narrower than the interval (hereinafter, referred to as “interval L”) between the two output light beams (that is, output light beams output from output waveguides 530a and 530b) at the outermost of the rows of the four output light beams side by side output from the optical modulation elements 520a and 520b.

In this case, since the polarization beam combining prism unit does not largely protrude than a width of the LN substrate and is not occupied unlike the related art, it is possible to miniaturize the optical modulation device. In addition, the polarization beam combining prism units 510a and 510b are disposed to be smaller than the width of the

LN substrate, in this case, it is possible to further miniaturize the optical modulation device. Further, since the polarization beam combining prism 510 includes the two polarization beam combining prisms as one unit, the polarization beam combining prism 510 can be disposed in a narrow range and contributes to miniaturization as compared with a configuration in the related art, in which the polarization beam combining prisms are discretely disposed in a wide range.

Further, in the optical modulation device 500 of the present embodiment, the optical modulation elements 520a and 520b and the polarization beam combining prism units 510a and 510b, which are primary factors for determining optical path disposition inside the housing 518, are respectively disposed to be line-symmetrical with respect to the line segment 180 parallel to the directions of the output light beams of the optical modulation elements 520a and 520b.

Generally, in a rectangular housing such as the housing 518 illustrated in FIG. 5, a distortion occurring at environmental temperature variation has geometrically approximate symmetry. For this reason, since the optical system after the light beam is input from the input optical fibers 504a and 504b until the light beam is output to the polarization beam combining prism units 510a and 510b is symmetrical with respect to the line segment 180, it is possible to make comparable degrees of positional deviation amount of the optical element in each of the optical systems at the environmental temperature variation.

As a result, a variation according to an environmental temperature variation, of an optical loss of two light beams included in two wavelength channels input from the input optical fibers 504a and 504b becomes a comparable degree, it is possible to prevent a loss difference between the wavelength channels according to the environmental temperature variation from occurring or increasing (accordingly, prevent a level difference of the transmitting light beams between the wavelength channels in the wavelength multiplex system from occurring or increasing) and to prevent a disparity of a transmission quality between the channels from occurring or increasing.

Further, in the optical modulation device 500 according to the present embodiment, since one output light beam combined by the wavelength combining prism 512 is output by one output optical fiber 516, only one hole for guiding the output light beam to the outside of the housing 518 may be provided in the housing 518.

For this reason, in the optical modulation device 500, a processing distortion and the like of the housing according to forming of the holes are reduced as compared with the related art in which two holes (or windows) for guiding the output light beam (output optical fiber) to the outside of the housing are provided in the housing. As a result, it is possible to reduce variation of the optical loss by reducing the distortion occurring at the environmental temperature variation of the housing 518. Furthermore, for example, by reducing the distortion of the housing 518 occurring when a cover is hermetically sealed with the housing 518 by being pressed and melted, it is possible to reduce variation of the optical loss before and after being hermetically sealed.

In the third embodiment described above, as an optical modulator, the two optical modulation elements 520a and 520b use one optical modulator 502 formed on one sheet of the substrate, but the second embodiment is not limited thereto. Two optical modulators including one optical modulation element formed on the each separate substrate may be used.

Further, in the third embodiment described above, as illustrated in FIGS. 5 and 6, as a wavelength combining element, the wavelength combining prism 512 in which reflection by 90 degrees occurs is illustrated, but the wavelength combining element is not limited thereto and can be a wavelength combining element having a predetermined configuration. For example, it is possible to use a wavelength combining element using reflection of an acute angle less than 90 degrees or a wavelength synthesizing optical system (including a plurality of optical elements) (hereinafter, also referred to as “wavelength combining section”). Generally, the wavelength combining element using such acute-angled reflection has little polarized wave dependence (polarized wave dependence loss, polarization dependent loss (PDL)) of an optical loss in the reflection. For this reason, if the wavelength combining element using the acute-angled reflection is used, it becomes easy to equalize the optical loss of each of the linearly polarized light beam components polarized in the orthogonal directions from each other included in the beams output from the polarization beam combining prism 510 and it is convenient in terms of design and manufacture.

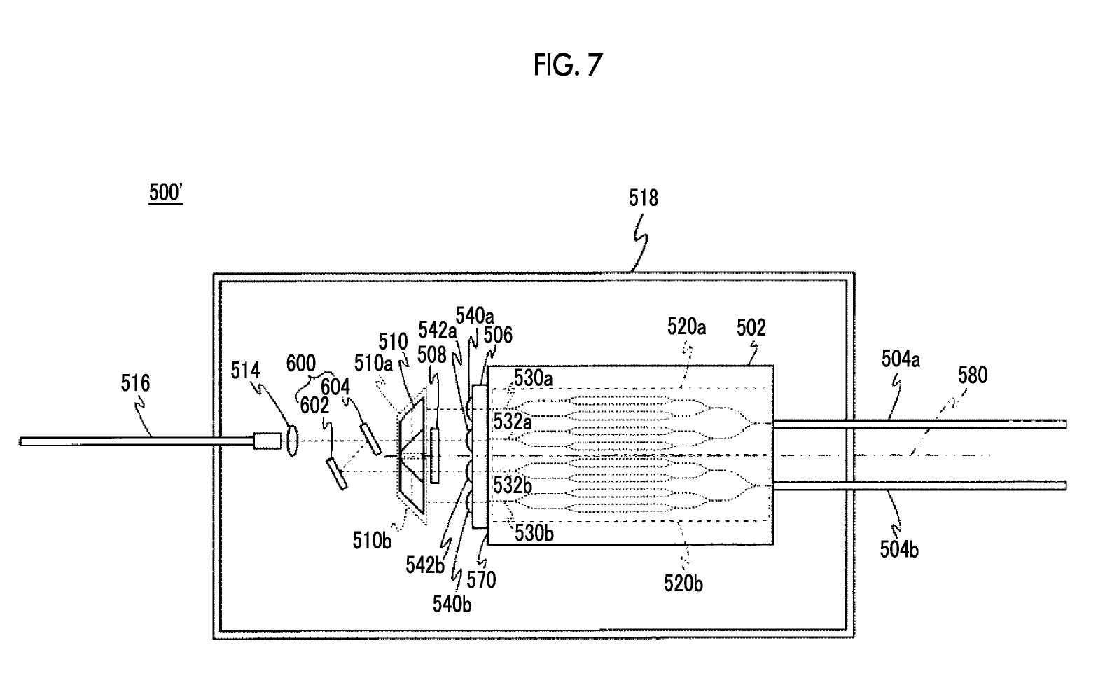

FIG. 7 is a view illustrating a modification example of the optical modulation device 500 illustrated in FIG. 5. An optical modulation device 500′ illustrated in FIG. 7 has the same configuration as the optical modulation device 500 and has an only difference with the optical modulation device 500 in that a wavelength combining section 600 is provided instead of the wavelength combining prism 512.

The wavelength combining section 600 is a wavelength combining the optical system using the acute-angled reflection described above and includes a mirror 602 and a wavelength combining plate 604. In the wavelength combining plate 604, a film which reflects light beams of one wavelength (wavelength of light beam input from the input optical fiber 504b in the present modification example) input at a specific acute-angle as an input angle and transmit another wavelength (wavelength of light beam input from input optical fiber 504a in the present modification example) is formed. This film can include, for example, a dielectric multilayer film.

The mirror 602 is a total reflection mirror, and reflects the beams output from the polarization beam combining prism unit 510b and allows the reflected beams to be input to the wavelength combining plate 604 at the specific acute-angle as an input angle. Accordingly, the beams input from the polarization beam combining prism unit 510b to the wavelength combining plate 604 are reflected by the wavelength combining plate 604, meanwhile, the beams output from the polarization beam combining prism unit 510a pass through the wavelength combining plate 604. As a result, the respective beams are combined into one output light beams and the resultant beam is output. Then, the one output light beam is coupled to the output optical fiber 516 via the coupling lens 514 and output.

In the modification example, since the wavelength combining section 600 using the acute-angled reflection is used, it is possible to realize appropriate optical-characteristics by reducing a difference between respective optical losses of the linearly polarized light beam components orthogonal to each other included in the output light beams.

### REFERENCE SIGNS LIST

100, 300, 500: optical modulation device
102, 302, 502: optical modulator
104a, 104b, 304a, 304b, 405a, 504b: input optical fiber
106: microlens array
306, 506: output microlens array
108, 308, 508: half-wavelength plate
110a, 110b, 310, 510: polarization beam combining prism
112a, 112b: optical path shift prism
114a, 114b, 514: coupling lens
116a, 116b, 316a, 316b, 516: output optical fiber
118, 314, 518: housing
120a, 120b, 320a, 320b, 520a, 520b: optical modulation element
130a, 132a, 130b, 132b, 330a, 332a, 330b, 332b, 530a, 532a, 530b, 532b: output waveguide
140a, 142a, 140b, 142b, 318a, 318b, 340a, 342a, 340b, 342b, 540a, 542a, 540b, 542b: microlens
170, 370, 570: substrate end surface
312: fiber coupling assembly
316: fiber array
318: coupling microlens array
322: window
324: hole
326: transparent glass
512: wavelength combining prism
600: wavelength combining section
602: mirror
604: wavelength combining plate

1. An optical modulation device comprising:
a first optical modulation element and a second optical modulation element each of which outputs two output light beams;
four lenses that respectively receive the four output light beams output from the two optical modulation elements;
a polarization rotation element that rotates polarization direction of one of the two output light beams from the first optical modulation element and polarization direction of one of the two output light beams from the second optical modulation element;
a first polarization beam combining element that combines the two output light beams from the first optical modulation element into one beam and outputs the combined beam; and
a second polarization beam combining element that combines the two output light beams from the second optical modulation element into one beam and outputs the combined beam,
wherein the light beams respectively output from the four lenses are directly input to the polarization rotation element and/or the first and second polarization beam combining elements without passing through an optical path shift prism.

2. The optical modulation device according to claim 1,
wherein the polarization rotation element is one optical element including an area through which one of the two output light beams from the first optical modulation element passes and an area through which one of the two output light beams from the second optical modulation element passes.

3. The optical modulation device according to claim 1, further comprising:
first and second optical path shift elements that respectively shift optical paths of the beams output from the first and second polarization beam combining elements to directions away from each other.

4. The optical modulation device according to claim 1,
wherein the first optical modulation element and the second optical modulation element are disposed to output the output light beams side by side and are disposed at a line-symmetrical position with respect to a line segment parallel to the output direction in which the output light beams are output side by side, and
the first polarization beam combining element and the second polarization beam combining element are disposed at the line-symmetrical position with respect to the line segment.

5. The optical modulation device according to claim 1,
wherein an optical component which comprises a parallel flat plate by an optical medium is disposed between the four lenses and the polarization rotation element and/or the first and second polarization beam combining elements.

6. The optical modulation device according to claim 1,
wherein the first and second optical modulation elements are optical modulation elements which perform phase shift keying or quadrature amplitude modulation.

7. The optical modulation device according to claim 1,
wherein the first and second optical modulation elements are respectively formed on separate substrates or are formed on an identical substrate side by side.

8. The optical modulation device according to claim 1,
wherein the four output lenses are an integration-type microlens array.
